(19) United States
(12) Patent Application Publication
(10) Pub. No.: US 2018/0108038 A1
(43) Pub. Date: Apr. 19, 2018

(54) FOOTWEAR COMPONENT REPLACEMENT SYSTEM AND METHOD

(71) Applicants: Greg Glover, Rockford, MI (US); Aaron Shedd, Rockford, MI (US)

(72) Inventors: Greg Glover, Rockford, MI (US); Aaron Shedd, Rockford, MI (US)

(21) Appl. No.: 15/728,567

(22) Filed: Oct. 10, 2017

Related U.S. Application Data
(60) Provisional application No. 62/409,058, filed on Oct. 17, 2016.

(51) Int. Cl. G06Q 30/02; G06Q 30/06; A43B 3/00; A43B 17/00; B65D 85/18; G09F 3/00

(52) U.S. Cl. CPC G06Q 30/0258; G06Q 30/0633; A43B 3/0089; G09F 2003/0208; B65D 85/187; G09F 3/0297; A43B 17/00

(57) ABSTRACT

A system and method for replacing a component of footwear. The system and method may involve manufacturing the footwear, and providing registration information on the footwear or a container for the footwear, or both. The registration information may enable a consumer to connect to a server assessable interface and collection of information from the consumer with respect to a type of footwear purchased. The consumer may be provided a replacement component that is substantially similar to a component initially provided at the time of manufacture.

### TECHNICAL FIELD

The present application relates to footwear, and more particularly toward a system or method for replacing components of the footwear.

### BACKGROUND

Most forms of footwear are comprised of components that may be readily replaceable and that are considered irreplaceable without substantially recreating the footwear. For instance, footwear may include one or more of the following: an upper, laces, a Strobel board, an insole or footbed, a midsole and an outsole. The upper, Strobel board, midsole, and outsole are often considered an irreplaceable component of the footwear without substantially reconstructing the footwear, whereas the laces, in many cases, can be replaced easily if one of the laces breaks or frays.

The footbed or insole is often one of the readily replaceable components of footwear. For instance, the wearer of the footwear can purchase an aftermarket footbed, such as a foot insert or insole sold under the brand name Dr. Scholl's, to replace the footbed provided initially with the footwear by the footwear manufacturer. In fields of heavy use, such as in construction, where the wearer is on their feet for long periods of time, the working life of a conventional footbed may be shorter than other non-replaceable components of the footwear. For instance, in heavy use, footwear may have a working life of about one-year whereas the footbed may be become degraded after 4-6 months leaving the footwear less comfortable than its initial purchase state. After the footbed has become degraded, some wearers replace the footbed with an aftermarket version, and others simply become accustomed to the less comfortable fit for the remaining working life of the footwear. The failure to obtain a new aftermarket footbed at this point in the working life of the footwear can affect the wearer's perception of the quality of the footwear and the wearer's loyalty to the brand of footwear.

Even if the wearer purchases the aftermarket footbed, there are several aspects of such an aftermarket footbed that can negatively affect the wearer's perception of the quality of the footwear and brand loyalty. Significant design, testing and analysis are often conducted by the footwear manufacturer in developing a footbed for a particular footwear offering. For instance, the footwear manufacturer may conduct testing to ensure to a degree of certainty that the footbed fits appropriately within the footwear and provides an enhanced level of comfort to the wearer. It is not uncommon for footwear manufacturers to use different footbeds for different footwear models within the manufacturer's lineup. In contrast, most aftermarket footbeds are designed to be a one-size fits all offering that can be used in footwear from different manufacturers and different footwear models from the same manufacturer. Many times, after market footbeds also require the consumer to cut or reshape the footbed, which can be frustrating and time consuming, and can lead to an improperly sized footbed. For these reasons, aftermarket footbeds often do not provide good fit and comfort for a particular footwear model, and may be considered a substandard replacement to the footbed initially provided in the footwear, thereby potentially negatively affecting the wearer's loyalty to the footwear brand.

### SUMMARY OF THE DESCRIPTION

The present disclosure is directed to a system and method for manufacturing footwear and replacing a component of the footwear. The system and method, in one embodiment, may involve manufacturing the footwear, providing information to the consumer to enable the consumer to connect to a server assessable interface, collecting information from the consumer with respect to a type of footwear purchased, and providing to the consumer a replacement component that is substantially similar to a component initially incorporated in the footwear during manufacture. The system and method according to one embodiment may include querying for confirmation from the wearer after a period of time that the wearer is still using the footwear and desires a replacement component, and wherein providing to the wearer the replacement component includes providing the replacement footwear if the wearer provides confirmation.

In one embodiment, the method may include the steps of manufacturing footwear including joining an upper to a sole and providing an insole within a void defined by the upper. The method may include providing registration information on at least one of the footwear and a footwear container for the footwear, the registration information including a reference to a registration network resource, and obtaining consumer identification data relating to the consumer and the footwear. After a period of time subsequent to purchase of the footwear, a message may be transmitted to the consumer with replacement component information relating to the replacement component for the footwear. In one configuration, the replacement component information may include at least in part an encoded hyperlink that, when accessed, initiates steps in an ecommerce server to serve a webpage with an electronic shopping cart that includes the replacement component without the need for the consumer to browse and add the replacement component to the shopping cart. After confirmation of shipping information and order details, the consumer may proceed to checkout and initiate shipment of the replacement component to the consumer.

The registration information in one embodiment may include a URL address that provides access to a registration server for the consumer to enroll to receive the replacement component in accordance with a replacement component program. The registration information may automatically identify the model number of the footwear purchased by the consumer or the consumer may provide this information to the registration server. The registration information may be provided on the footwear container prior to or after the footwear is associated with the footwear container. In one example, the size and model label provided on the footwear container may include the registration information. As another example, the registration information may be provided on the footwear, such as on the size label.

A system according to one embodiment of the present disclosure may include one or more of the following: registration information, a registration server, a consumer database, a communication server, and a transaction server. The registration information may be disposed on at least one of the footwear and a footwear container for the footwear. The registration server may be accessible via the registration information, and may be configured to communicate a user interface to a consumer device operated by the consumer. The registration server may be configured to obtain consumer identification data relating to the consumer.

In one embodiment, the consumer database may store the consumer identification data and footwear data relating to the footwear purchased by the consumer, and the communication server may be configured to communicate a message to the consumer based on information stored in the consumer database. The message may include replacement component information relating to the replacement component for the footwear. The transaction server may be accessible via a network link provided in the message to the consumer, and may be configured to initiate shipment of the replacement component to the consumer based on consumer feedback.

A system and method according to one embodiment of the present disclosure may facilitate manufacture of footwear and providing a consumer with a replaceable component of the footwear after manufacture. This may enable the consumer to extend the useable life of the footwear, and maintain consumer loyalty and confidence in the durability and wear of the footwear.

These and other advantages and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a system according to one embodiment;

FIG. 2 is a method according to one embodiment;

FIG. 3 is a footwear unit according to one embodiment;

FIG. 4 is a footwear unit according to another embodiment; and

FIGS. 5 and 5A is footwear according to yet another embodiment.

### DESCRIPTION

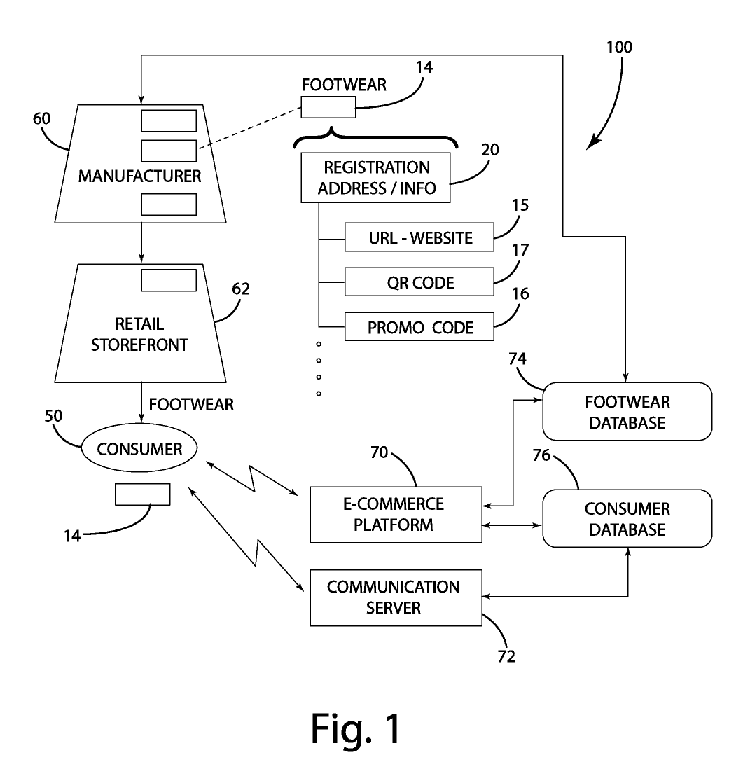

A system according to one embodiment is shown and described in conjunction with FIG. 1, and generally designated 100. The system 100 may include manufacturing footwear. The system 100 may enable providing information to a consumer 50 to facilitate a consumer connection to a server assessable interface, collecting information from the consumer 50 with respect to a type of footwear purchased and identification information relating to the consumer 50, and providing to the consumer 50 a replacement component that is substantially similar to a component initially provided with the footwear after a period of time has elapsed since the footwear was purchased and manufacture. For purposes of disclosure, the system 100 in the illustrated embodiment of FIG. 1 is depicted with several components including, for example, an ecommerce platform 70, a communication server 72, a manufacturing system 60, a retail storefront 62, a footwear database 74 and a consumer database 76. It should be understand that the system 100 may include all or a subset of the components depicted in the illustrated embodiment. It should be understood that the system 100 may include any combination of the one or more components described in the illustrated embodiment along with any of the one or more components described herein.

4. Footwear Manufacture and Point of Sale

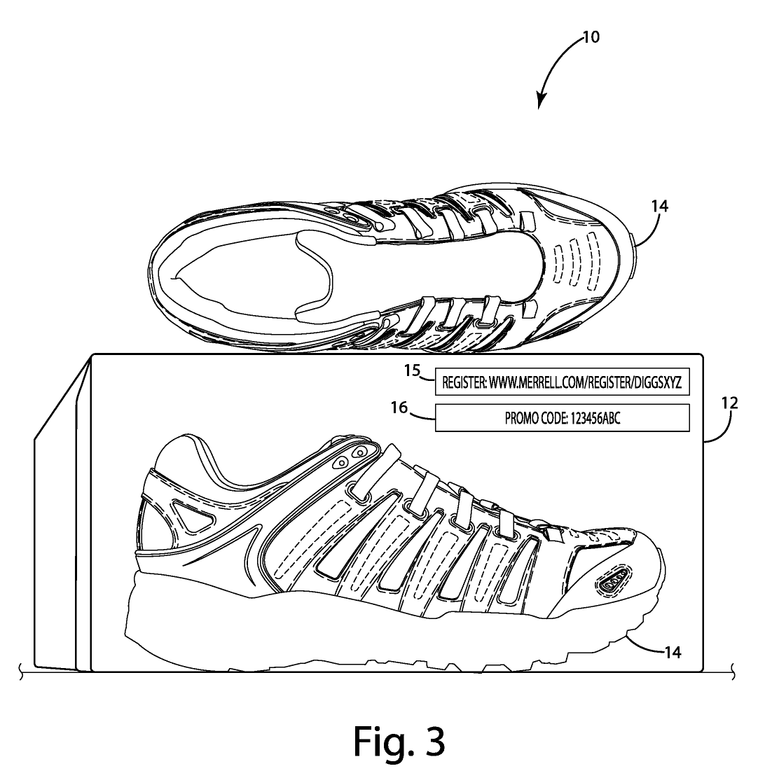

In the illustrated embodiment of FIG. 1, footwear 14 is manufactured and packaged as a footwear unit 10 for sale to a customer or consumer, who is possibly also the ultimate wearer of the footwear 14. Such footwear 14 is shown in detail in the illustrated embodiments of FIGS. 3-5 and may include several components, as discussed herein, that are readily replaceable by the consumer. For instance, the footbed 11 or the laces 19, or both, may be readily replaced by the consumer 50. In some circumstances, the consumer 50 may wear out or break such replaceable components after the footwear 14 has been in use for a period of months, and has likely forgotten the details specific to obtain a replacement component.

The footwear unit 10 may be manufactured in a manufacturing system 60 in various stages, and may involve providing a sole and jointing an upper to the sole to define a void in which a foot can be accepted. The manufacturing stages may be distributed across several manufacturing centers or conducted at a single manufacturing center. For purposes of disclosure, the manufacturing system 60 is described in connection with manufacturing several aspects of the footwear unit 10, including for instance the footwear 14. It should be understood that the manufacturing system 60 may involve manufacture of additional or fewer aspects, including without limitation the upper and sole. In the illustrated embodiment, the footwear 14 and footwear container 12 may be manufactured within the manufacturing system 60.

In one embodiment, the upper of the footwear 14 can be formed of a lightweight and flexible material, for example leather or synthetic materials, and can provide ventilation to the wearer's foot. The sole can include multiple layers, for example an insole, a midsole, and an outsole. The insole or footbed 11 is sometimes positioned within the upper to provide added comfort to the wearer's sole. The midsole is generally joined to the upper and provides energy absorption, often in the heel strike area. The outsole may be formed from a wear resistant material and may include tread elements to provide the desired degree of traction for the intended application of the article of footwear.

The footwear 14 may include one or more additional components, including, for example, a tongue 13, lacing 19, and a Strobel board. The upper may be sewn to the Strobel board during manufacture and attached to the sole. Some or all of the components incorporated into the footwear 14 may be readily replaceable. For purposes of disclosure, and without limitation, examples of such readily replaceable components include the footbed and lacing. It should be understand that any component of the footwear may be considered readily replaceable according to one or more embodiments described herein.

At least one of the footwear 14 and footwear container 12 may include registration information 20 or an identifier for a network resource affixed or disposed thereon. For instance, the registration information 20 may take the form of a unified resource locator (URL) 15 or webpage address that directs the consumer 50 to a network accessible resource, such as an ecommerce platform or ecommerce server 70. The network in the illustrated embodiment may be the internet or an intranet or a combination thereof. The URL 15 provided in the registration information 20 may be provided in clear text (e.g., www.merrell.com) or may be encoded in a manner accessible to the consumer 50. For instance, the URL 15 may be included in a matrix barcode 17, also known as a quick response (QR) code, or a barcode, one or more of which may be decoded and utilized by a camera-equipped smartphone.

In one embodiment, the registration information 20 may include an identifier (e.g., the URL 15) to the network accessible resource as well as information that identifies one or more aspects of the footwear 14. As an example, the registration information 20 may include model, brand, or size information, or any combination thereof with respect to the footwear 14. This additional information included in the registration information 20 may be provided in clear text or encoded in a manner similar to the URL 15. For instance, the model and/or brand of the footwear 14 may be provided in the URL (e.g., www.merrell.com/diggs). In one embodiment, the registration information 20 may be a matrix barcode 17 with a URL that includes encoded information that initiates auto-population of a registration form served by the network accessible resource or ecommerce platform. Alternatively or additionally, the registration information 20 may direct the consumer 50 to such a registration form that may prompt the consumer 50 to enter identifying information for the footwear 14, such as the model and size of the footwear 14.

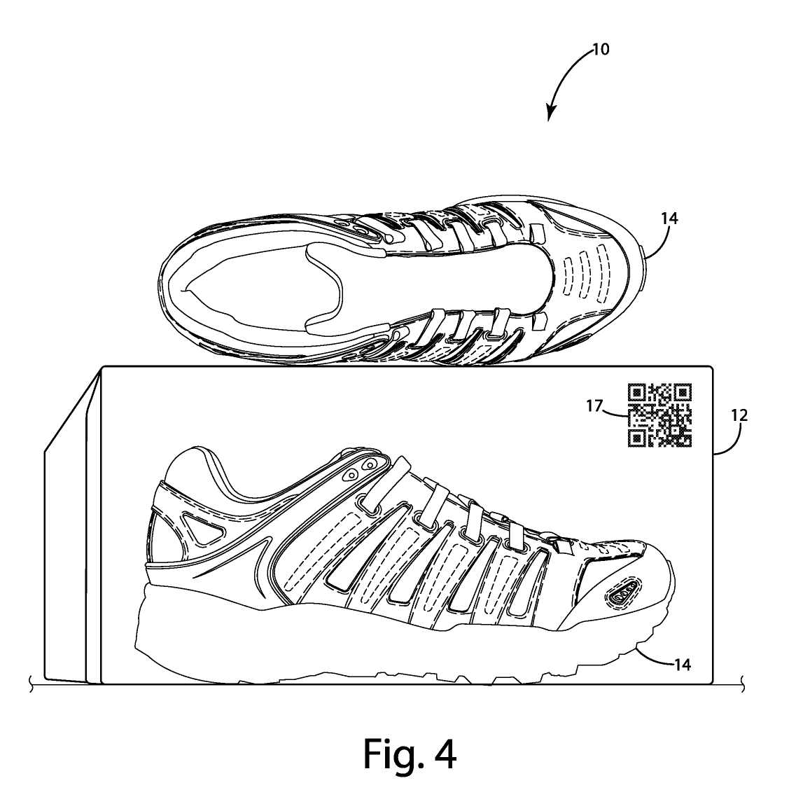

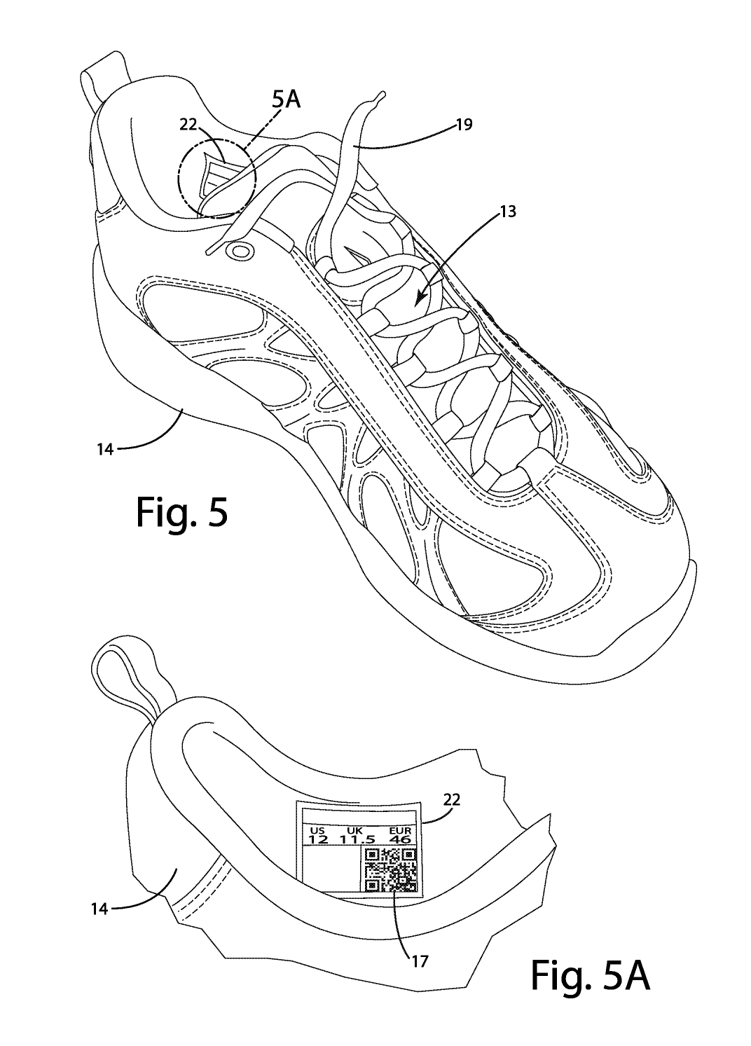

The registration information 20 according to the illustrated embodiment of FIGS. 3 and 4 is provided directly on the footwear container 12. In this way, the registration information 20 may be permanently affixed (although not necessarily) to the footwear unit 10—e.g., the registration information 20 may be printed on the footwear container 20 or take the form of a label adhered to the footwear container 12. In one embodiment, the footwear container 12 may be manufactured for a brand of footwear but without regard to a specific model of footwear. As a result, the registration information 20 may be disposed on the footwear container 12 prior to being associated with a specific model of footwear 14. The registration information 20 in this circumstance may include information to access the ecommerce platform 70 or server but not information to auto-populate model information or automatically identify the model information. In one embodiment, the registration information 20 may be provided on the size label affixed to the footwear container 12 after the footwear container 12 has been associated with the footwear 14. Additionally or alternatively, the registration information 20 may be provided on the footwear 14 so that regardless of which footwear container 12 is ultimately associated with the footwear 14, the registration information 20 on the footwear 14 may be provided with model and/or size information. For instance, the registration information 20 depicted in the illustrated embodiment of FIGS. 5 and 5A is provided on the tag 22 sewn to the tongue 13 of the footwear 14. This tag 22 may include registration information such as size and model information printed in clear text thereon. The registration information 20 may also be disposed on the tag 22 in a manner similar to one or more embodiments described above, including, for example, a matrix barcode 17.

The registration information 20 associated with the footwear unit 10 in one embodiment may include a promotional code 16. The promotional code 16 may facilitate identification of the footwear unit 10, and may facilitate control over enrollment in the consumer database 76 as described herein. In the illustrated embodiment, the promotional code 16 may be a unique identifier affixed to the footwear container 12. The unique identifier may be a one-time enrollment identifier that, once used to enroll the consumer 50 for a particular footwear 14, cannot be used subsequently to enroll another consumer 50 for footwear 14 without additional approval from the manufacturer. If the same consumer 50 purchases another footwear unit 10, a new unique identifier may be provided, thereby enabling enrollment of the consumer 50 for the newly purchased footwear 14 for replacement components.

The footwear unit 10 or a plurality thereof may be provided to a retail storefront 62 or retail outlet, including the registration information 20. The retail storefront 62 may be any type of outlet from which a consumer may purchase the footwear 14, including, for instance a traditional brick and mortar point of sale, or network accessible storefront for online purchasing. In some circumstances, operators of a retail storefront 62 may attempt to remove or cover up the registration information 20 from the footwear unit 10, particularly in cases where the registration information 20 is provided loosely within the footwear container 12. By permanently affixing the registration information 20 to the footwear container 12 or the footwear 14, or both, the footwear unit 10 may be considered more resistant to such efforts.

5. Replacement Component Enrollment and Fulfillment

The system 100 in the illustrated embodiment of FIG. 1 may include one or more of the following: an ecommerce server 70 or ecommerce platform, a communication server 72, a footwear database 74, and a consumer database 76.

The system 100 may include a retail storefront 62 or point-of-sale system as discussed herein. After the consumer 50 has purchased the footwear unit 10, including the footwear 14, from the retail storefront 62, the consumer 50 may utilize one or more of the embodiments outlined herein to facilitate obtaining one or more replacement components for the footwear 14. The replacement components according to one embodiment may be provided after a predetermined time period that is determined based on a projected degree of wear. In one embodiment, the consumer 50 may utilize the registration information 20 provided on the footwear container 12 or footwear 14, or both, to initiate communication with a registration server. The registration server is depicted in the illustrated embodiment as being incorporated into the ecommerce server or platform 70, but it should be understood that the registration server may be separate from the ecommerce server 70.

In the illustrated embodiment, the ecommerce server 70 may be configured to provide a consumer interface to the consumer 50 in response to access via the registration information 20. For instance, the ecommerce server 70 may respond to an internet request generated by a consumer device operated by the consumer (e.g., a smartphone or personal computer) and based on the registration information 20. The response from the ecommerce server 70 may include a set of instructions to facilitate generation of a consumer interface on the consumer device. The set of instructions, for instance and without limitation, may include HyperText Markup Language (HTML) as well as JavaScript and Cascading Style Sheets (CSS), or any combination thereof. Using the consumer interface, the consumer 50 may submit to the ecommerce server 70 details regarding the consumer 50 and the footwear 14 purchased by the consumer 50. Such details may include one or more of the consumer's name, mailing address, email address, and the model and size of the footwear 14. The ecommerce server 70 may communicate with a footwear database 74 regarding model or part numbers for replacement components associated with the footwear 14 identified by the consumer 50. The ecommerce server 70 may also communicate with a consumer database 76 to store the details, or aspects thereof, submitted by the consumer 50 to the ecommerce server 70. In this way, the ecommerce server 70 may enable the consumer 50 to enroll in a replacement program for footwear or footwear components, or any combination thereof. The replacement program may be arranged to provide one or more replaceable components of the footwear 14 to the consumer 50 after a period or periods of time have elapsed since the consumer 50 purchased the footwear 14. Enrollment may involve utilizing the registration information 20 to provide the registration server with consumer information that can be stored and queried at a later time in the consumer database 76.

In the illustrated embodiment, the ecommerce server 70 may include one or more of the following: a processor, memory, an input interface and an output interface. The input interface may include one or more input communication interfaces, including, for example, internet communication capabilities. Likewise, the output interface may include one or more output communication interfaces, including at least one internet interface. The ecommerce server 70, functioning as a registration server, may be configured to serve web pages and facilitate consumer enrollment in a replacement program for footwear, as outlined herein.

The system 100 in the illustrated embodiment of FIG. 1 may include a communication server 72, which similar to the registration server, may be incorporated into the ecommerce server 70—although the communication server 72 in FIG. 1 is shown separate from the ecommerce server 70. The communication server 72 may be similar in several respects to the ecommerce server 70, and may include one or more of the following: a processor, memory, an input interface and an output interface. The communication server 72 may be configured to transmit messages via the internet to the consumer 50. More specifically, the communication server 72 may be configured to transmit email messages to the consumer 50.

The communication server 72 may be communicatively coupled to the consumer database 76. In one embodiment, the communication server 72 may facilitate generation of one or more electronic messages, based on information stored in the consumer database, to initiate steps for replacing a component of the footwear 14. For instance, a query may be conducted on the consumer database 76 for one or more consumers 50 that are determined to be eligible for a replacement component for respective footwear purchased and registered by the one or more consumers 50. Eligibility may be determined based on a length of time associated with the wear life of the replacement component. As an example, in the context of a replaceable footbed, it may be predetermined that the footbed has a wear life of six months. Eligibility for a replacement footbed may be determined at approximately six months from the date of purchase. It should be understood that a variety of criteria may be utilized for determining eligibility for a replacement component, and that use of wear life as a criterion is one example. With the results of a query for replacement components and associated consumers 50 that are eligible for the respective replacements, the communication server 76 may generate and transmit one or more electronic messages to each consumer 50 identified in the query.

The electronic message in one embodiment may include encoded information that facilitates providing a replacement component to the consumer 50. The electronic message may be generated based on a template including information, such as brand name or general contact information, and formatting that may be utilized for all or a subset of electronic messages sent by the communication server 74 in connection with providing consumers replacement components for footwear.

At least part of the encoded information provided in the message may be representative of a model or part number for the replacement component. For instance, the encoded information may include an identification code that identifies the part number or that provides a key to a lookup table from which the part number may be obtained. The encoded information may also include consumer related information represented in a similar manner. For instance, the encoded information may include a key or identifier from which the consumer's name and shipping information may be obtained from a lookup table. Additionally or alternatively, the encoded information may include an identification code that identifies the consumer's name and shipping information. The encoded information may be encrypted so that information is not provided in clear text or human readable form.

In one embodiment, the encoded information may be provided in the form of a hyperlink included in the electronic message sent from the communication server 72 to the consumer 50. The consumer 50 may utilize this hyperlink to initiate communication with the ecommerce server 70 via the consumer device. The ecommerce server 70 may respond to an access request based on the hyperlink by automatically populating an electronic shopping cart with the replacement component associated with the consumer 50. As described herein, the hyperlink may include encoded information representative of the product number for the replacement component. Upon receiving an access request via the network based on the hyperlink with the encoded information, the ecommerce server 70 may auto-populate the electronic shopping cart with the replacement component represented in the encoded information. Additionally, or alternatively, the ecommerce server 70 may associate the current network session with the shipping information represented in the encoded information. In this way, the consumer 50 may checkout without the need to enter the shipping information. The consumer 50 may confirm the shipping information and proceed toward fulfillment of the transaction to replace the replaceable component.

In one embodiment, by auto-populating the electronic shopping cart with the replacement component, the consumer 50 may not need to browse the ecommerce server 70 for the replacement component to find and add it to the electronic shopping cart. Further, the consumer 50 may not need to recall the specific model of the footwear 14 or look up the model number of the replacement component in order to obtain the replacement component. The ecommerce server 70 may process the encoded information to decode the shipping information and/or the part number of the replacement component, and track this information for the network session. For instance, the ecommerce server 70 may receive the encoded information as part of a POST or GET method in accordance with the HTML standard, and process this information to identify one or more of the consumer's identity, the replacement component, and shipping information for the consumer 50. As mentioned above, the encoded information may be encrypted by the communication server 72, and the key for the encrypted information may be accessible by the ecommerce server 70.

The ecommerce server 70 in one embodiment may be configured to serve web pages and to facilitate consumer browsing or ordering of items, including footwear or footwear components, or both. For instance, the ecommerce server 70 may provide a network-based interface through which a consumer 50 can browse and shop for footwear or components. The ecommerce server 70 may utilize an electronic shopping cart to facilitate selection and ultimate ordering of footwear or components. For example, the consumer may select using a consumer interface served via the internet to place one or more footwear into an electronic shopping cart.

The electronic shopping cart may maintain a list of items selected by the consumer 50 until the consumer 50 is ready to checkout or proceed to order fulfillment. During the order fulfillment stage, the consumer 50 may provide details related to a shipping address and payment information to proceed to pay for and initiate shipment of the items included in the electronic shopping cart. The ecommerce server 70 may communicate with a payment gateway to confirm payment authorization based on payment details provided by the consumer 50. After receiving an indication of authorization, the ecommerce server 70 may communicate with an order fulfillment server (not shown) that manages collection and shipment of the items ordered by the consumer 50. In the case of providing the replacement component, the electronic shopping cart may be auto-populated with the replacement component as mentioned above. Further, the ecommerce server 70 may be configured to skip obtaining payment information to provide the replacement component to the consumer 50 for free. Alternatively, payment information may be collected to pay for the replacement component and/or to cover a handling cost associated with shipment of the replacement component.

6. Method of Operation

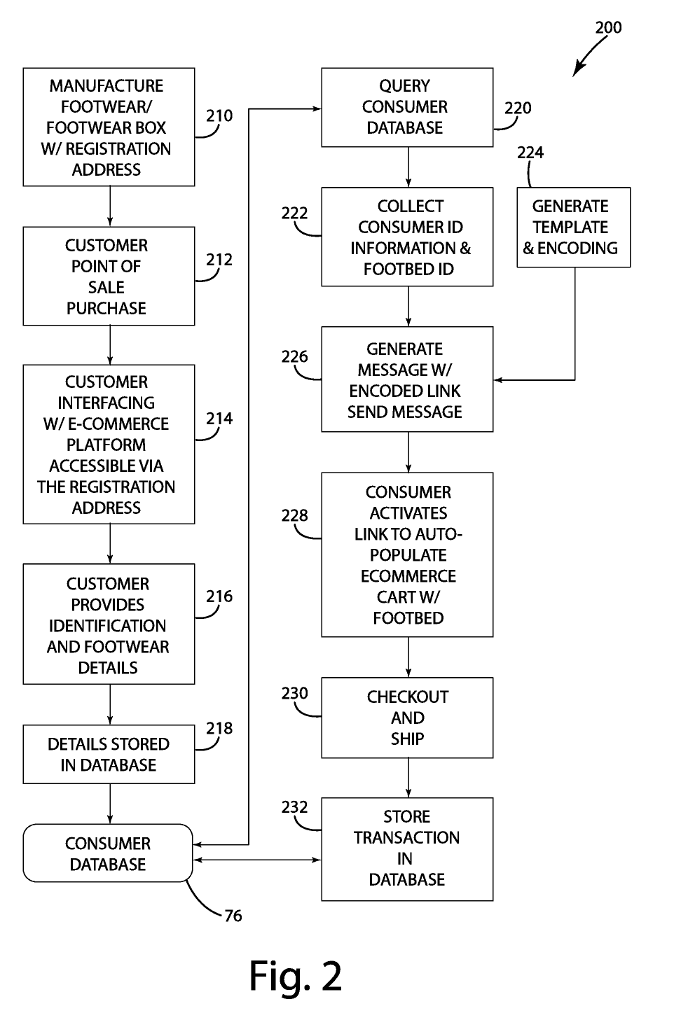

A method according to one embodiment is shown and described in FIG. 2, and generally designated 200. The method may include one or more of the following steps: manufacturing footwear, providing information to the consumer to enable the consumer to connect to a server assessable interface, collecting information from the consumer with respect to a type of footwear purchased, and providing to the consumer a replacement component that is substantially similar to a component incorporated during manufacture of the footwear.

In the illustrated embodiment, the method includes manufacturing footwear by forming a sole and an upper, and joining the upper to the sole to form a void that accepts a foot. Forming the sole may involve injection molding in multiple layers with different or similar types of materials. The upper may be formed in a variety of ways, including knitting techniques and die cut techniques. The upper may be of unitary construction or multiple pieces joined together.

The method may include providing the footwear or a footwear container, or both, with registration information, such as a registration address. Step 210. The registration information, as described herein, may be provided on the footwear or footwear container in a variety of ways, and may be in human readable form or in an encoded form that can be processed by a consumer device (e.g., a smartphone). Examples of encoded forms include barcodes and matrix bar codes. The registration information may facilitate identification of the footwear or include a model number of the footwear, and may be provided on the footwear or the footwear container at the time of manufacture. The registration information may be based in part on information obtained from a footwear database. The registration information in one embodiment may be a URL address, such as www.merrell.com/diggs/modelABC or www.merrell.com/register.

After a consumer has purchased the footwear, the consumer may utilize the registration information to register with a replacement component system. Steps 212, 214. The replacement component system may include a network enabled system that responds to an access attempt via the registration information by a consumer device over the internet. The replacement component system may communicate, over the internet, instructions to generate a consumer interface on the consumer device for facilitating completion of the registration process. For instance, the replacement component system may serve a webpage to the consumer device to facilitate entry by the consumer of identification information to be stored in a consumer database 76. The registration information, such as the hyperlink and a GET or POST method, may provide identifying information about the footwear to the replacement component system, or the consumer may provide these details in the registration process. Step 216. The method may involve storing the consumer identification information and footwear details in the consumer database 76, which can be queried at a later time. Step 218.

In one embodiment, the consumer may provide a promotional code to the replacement component system that is generated at the time of manufacture and provided in the registration information. The promotional code may be unique and associated with only one set of footwear. Once a consumer has registered using the promotional code, the promotional code may not be used again for enrolling in a replacement component program without additional approval.

The method according to the illustrated embodiment may include querying the consumer database 76 on a periodic basis or a semi-periodic basis for consumers that have registered and who may be ready for a replacement component. Qualification for a replacement component may be based on a determined wear life of the replacement component and the amount of time since the purchase date of the footwear. Step 220. Based on the results of the query of the consumer database 76, consumers may be identified for follow-up communication. Identification may be conducted manually or automatically. The identified consumers and associated footwear information (e.g., footwear model and part number for the replacement component) may be collected, and provided to a message encoder that generates an electronic message for transmission to the consumer. The method may include generating a message template and an encoder configured to generate encoded information for transmission to the consumer. Step 224. Generation of the message may involve encoding at least one of an identifier for the replacement component and/or identity information for the consumer. This encoded information may be provided in a hyperlink included in an email message to the consumer. Step 226. Activation of the hyperlink by the consumer may initiate the process of obtaining the replacement component.

In the illustrated embodiment, the method may include responding to an access attempt via the hyperlink by serving a webpage that identifies an electronic shopping cart. The electronic shopping cart may be automatically populated with the replacement component so that the consumer need not browse an ecommerce site to identify the replacement component for checkout. In other words, the electronic shopping cart may automatically add the replacement component in response to activation of the hyperlink, and enable the consumer to checkout with the replacement component immediately after loading the webpage in response to activation of the hyperlink. Step 230. The consumer at this stage may provide additional information such as the wear level of the footwear, interests, field of use for the footwear, and a picture of the product in action. The consumer may also be presented with additional footwear options or components that he may find interesting. After the consumer has proceeded toward fulfillment in ordering the replacement component, the method may store the transaction in the consumer database 76 for potential queries in the future. In one embodiment, the consumer may be entered into a sweepstakes after proceeding through the process of replacing the footwear component.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s). The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

The embodiments of the invention in which an exclusive property or privilege is claimed are defined as follows:

1. A method of using footwear, the method comprising:
joining an upper to a sole to form a footwear with a void that accepts a foot;
incorporating a replaceable component into the footwear;
providing registration information on at least one of the footwear and a footwear container configured to receive the footwear, the registration information including a reference to a registration network resource;
communicating, based on a request to the network resource, a consumer interface to a consumer network device;
obtaining, via the consumer interface, consumer identification data relating to the consumer;
storing the consumer identification data and footwear data relating to the footwear purchased by the consumer in a consumer database;
after a period of time subsequent to purchase of the footwear, transmitting a message to the consumer based on information stored in the consumer database, the message including replacement component information relating to a new component for replacing the replaceable component of the footwear; and
shipping the new component to the consumer in response to authorization from the consumer.

2. The method of claim 1 wherein the new component is a replacement footbed for the footwear, and comprising installing the replacement footbed in the void of the footwear to produce a refurbished footwear.

3. The method of claim 1 comprising generating encoded information that identifies the replacement component based on the footwear data stored in the consumer database; and
said transmitting a message including providing a network link to a network resource, the network link including encoded information that identifies the replacement component.

4. The method of claim 3 comprising in response to access to the network resource via the network link, auto-populating an electronic shopping cart with the replacement component and shipping information relating to the consumer.

5. The method of claim 4 wherein the encoded information included in the network link provides a basis for the network resource to auto-populate the electronic shopping cart with the replacement component.

6. The method of claim 3 wherein the network link is a uniform resource locator that provides a reference to a webpage accessible from the network resource.

7. The method of claim 1 wherein said providing registration information includes providing a network address on the footwear container.

8. The method of claim 1 wherein said providing registration information includes providing a matrix barcode on the footwear container, the matrix barcode including the reference to the registration network resource.

9. The method of claim 8 wherein the matrix barcode includes a network registration link that enables access to the registration network resource, the network registration link including footwear data relating to a model of footwear purchased by the consumer.

10. The method of claim 1 comprising providing a unique identifier on the footwear container; and
querying the consumer for the unique identifier to confirm enrollment in the consumer database, wherein the network resource enables enrollment of the consumer if the unique identifier has not been previously utilized for enrollment in the consumer database.

11. A system for an article of footwear, the system comprising:
an upper including one or more footwear elements to define a void for receiving a foot and a replacement component removably associated with the footwear;
a sole secured to the upper, the sole including a ground contacting surface;
registration information disposed on at least one of the footwear and a footwear container configured to receive the footwear;
a registration server accessible via the registration information, the registration server configured to communicate a user interface to a consumer device operated by a consumer, the registration server configured to obtain consumer identification data relating to the consumer;
a consumer database that stores the consumer identification data and footwear data relating to the footwear purchased by the consumer;
a communication server configured to communicate a message to the consumer based on information stored in the consumer database, the message including replacement component information relating to the replacement component for the footwear; and
a transaction server accessible via a network link provided in the message to the consumer, the transaction server configured to initiate shipment of the replacement component to the consumer based on consumer feedback.

12. The system of claim 11 wherein the replacement component is a replacement footbed for the footwear.

13. The system of claim 11 wherein the communication server is configured to generate encoded information that identifies the replacement component based on the footwear data stored in the consumer database, wherein the communication server is configured to incorporate a network link to the transaction server in the message, wherein the network link includes the encoded information that identifies the replacement component.

14. The system of claim 13 wherein the transaction server is configured to auto-populate an electronic shopping cart with the replacement component and shipping information relating to the consumer based on the encoded information provided in the network link.

15. The system of claim 11 wherein the registration server and the transaction server are incorporated into an ecommerce server that enables the consumer to purchase at least one of footwear and footwear related components.

16. The system of claim 11 wherein the consumer database is communicatively coupled to a footwear database that stores information relating to footwear models and replacement components for the footwear models.

17. The system of claim 11 wherein the registration information is a network address disposed on the footwear container.

18. The system of claim 11 wherein the registration information is a matrix barcode disposed on the footwear container, the matrix barcode includes a network address to the registration server.

19. The system of claim 11 wherein the registration information is a matrix barcode disposed on a tongue of the footwear.

20. The system of claim 11 comprising a unique identifier disposed on the footwear container, and wherein the registration server is configured to enroll the consumer in the consumer database if the unique identifier has not been previously utilized for enrollment in the consumer database.
